(19) United States
(12) Patent Application Publication
(10) Pub. No.: US 2018/0201261 A1
(43) Pub. Date: Jul. 19, 2018

(54) METHOD FOR CHECKING THE PLAUSIBILITY OF A CONTROL DECISION FOR SAFETY MEANS

(71) Applicant: Robert Bosch GmbH, Stuttgart (DE)

(72) Inventors: Joerg Moennich, Stuttgart (DE); Heiko Freienstein, Weil Der Stadt (DE); Josef Kolatschek, Weil Der Stadt (DE)

(21) Appl. No.: 15/743,365

(22) PCT Filed: May 24, 2016
(86) PCT No.: PCT/EP2016/061650

§ 371 Date: Jan. 10, 2018

(30) Foreign Application Priority Data
Jul. 17, 2015 (DE) 102015009082.8

(51) Int. Cl. B60W 30/095; B60W 50/00; G06K 9/32; G06K 9/00

(52) U.S. Cl. CPC B60W 30/095; B60W 50/0097; G06K 2209/01; G06K 9/00805; B60W 2420/42; G06K 9/325

(57) ABSTRACT

A method for checking the plausibility of a control decision for a safety device of a vehicle includes detecting a regulatorily standardized feature of a collision object using a surroundings sensor system, such as a video camera, and enabling the control decision as a function of the detected feature, such as a vehicle license plate, trademark, or emblem.

### CROSS-REFERENCE TO RELATED APPLICATIONS

The present application is the national stage of International Pat. App. No. PCT/EP2016/061650 filed May 24, 2016, and claims priority under 35 U.S.C. § 119 to DE 10 2015 009 082.8, filed in the Federal Republic of Germany on Jul. 17, 2015, the content of each of which are incorporated herein by reference in their entireties.

### FIELD OF THE INVENTION

The present invention relates to a method for checking the plausibility of a control decision for a safety device of a vehicle, a corresponding computer program, an electronic memory medium, and a corresponding device.

### BACKGROUND

A device for determining a mass of a motor vehicle that is situated in the surroundings and detected with the aid of a surroundings sensor system is known from DE 103 37 619 A1, the determination of the mass of the motor vehicle being based on detecting the license plate of the motor vehicle and subsequently comparing the detected vehicle license plate to a database containing an association of the vehicle license plate with the mass of the motor vehicle.

A method for video-based vehicle license plate recognition is known from “Internet-Vision Based Vehicle Model Query System Using Eigenfaces and Pyramid of Histogram of Oriented Gradients,” Anakavej et al., International Conference on Signal-Image Technology & Internet-Based Systems (SITIS), 2013.

### SUMMARY

A disadvantage of the method known from the related art is that, although the mass is an important factor in determining the severity of a collision, it represents only a portion of the collision severity. Further parameters result from the speed and the collision geometry, which are not included in the known method. In addition, the use of a large database with an association of license plates with the mass of a motor vehicle is somewhat problematic, or at least controversial, for reasons of data protection and data transmission.

The present invention is directed to a reliable plausibility check of an imminent impact having a relevant collision severity, based on the detection of a regulatorily standardized feature of a collision object.

The present invention is based on the finding that a regulatorily standardized feature of a collision object, such as a vehicle license plate for two-track vehicles liable to registration, ensures a minimum mass which is potentially hazardous in a collision. The license plate in high-resolution images is a perfect object for video-based detection, in particular even when short-range video sensor systems are used. The license plate is usable for mono cameras and stereo video cameras for making highly reliable decisions. The impact zone and the collision speed can be obtained, or at least estimated more accurately, from special computations, based on the positions in image sequences or in the optical flow.

Alternatively, lidar, ultrasonic, and radar sensor systems can be used instead of video sensor systems. For the sensor system, generally referred to as “surroundings sensor system,” it is important that a detection of a regulatorily standardized feature, such as a vehicle license plate, is possible.

Other regulatorily standardized features of a vehicle are warning signs or hazard labels. Trademarks or emblems are also conceivable.

The object class as a relevant collision object can be set based on the detection of the regulatorily standardized feature at a certain position in the image. A minimum collision severity can be reliably predicted based on the positions of the regulatorily standardized feature in at least two successive images. This method is particularly suited as an independent safety path for precollision applications in passive safety for vehicles. In the context of passive safety for vehicles, precollision applications refer to applications that are applied prior to the actual collision, i.e., prior to the first contact with the collision object.

Furthermore, the provided method can be used whenever a significant intervention is made in the vehicle trajectory. Any intervention that causes an acceleration of greater than 0.5 g, in particular greater than 1 g, is significant. It is irrelevant whether the intervention takes place longitudinally (braking, acceleration, for example) or transversely (evasive maneuvering, lane-keeping, for example) with respect to the longitudinal extension of the vehicle.

In addition, the control of “aggressive” a reversible restraint device can be advantageously ensured by the provided method. In the present case, “aggressive restraint device” is understood to mean a restraint device that has a significant effect on the position or orientation of a vehicle occupant. This includes at least seat belt tensioners, which engage at forces greater than 800 kN.

The provided method is very comprehensible. Thus, its reliability may be argumentatively demonstrated without extremely long deliberations over so-called evidence (argumentation via expert knowledge).

A fundamental task of the plausibility check of control decisions, i.e., enabling the control of safety means, is determining the collision severity. Plausibility checking is a function/combination of impact speed, masses, and mass ratios, as well as rigidities and the collision geometry. Triggering an irreversible restraint device such as seat belt tensioners or airbags demands ultra-high dependability, i.e., maximum reliability, of the system. In other words, the probability of a relevant collision must be virtually 100% in order to justify a triggering, i.e., control.

The provided method, as a safety path for much more complex algorithms or methods for characterizing the collision severity based on the above-mentioned features or input variables, can be used for evaluating head-on, side, and rear collisions. A safety path that is simple and reliable is particularly meaningful.

The present invention is based on the finding that regulatorily standardized features, such as vehicle license plates, are highly specific and therefore very well detectable by surroundings sensor systems, in particular video sensor systems.

One simple task is the reliable detection of a precisely known pattern in a signal having a high signal-to-noise ratio. The reliable detection (localization, classification) of a vehicle license plate in a video image is such a task, since the appearance of vehicle license plates is subject to clear guidelines (i.e., regulatorily standardized), and license plates are optimized for recognizability and legibility. In addition, license plates are not allowed to be arbitrarily varied.

The provided method is based on the steps of detecting a regulatorily standardized feature of a collision object with the aid of a surroundings sensor system, and enabling the control decision as a function of the detected feature.

Proceeding from these basic steps, the provided method includes a number of specific embodiments.

In one advantageous specific embodiment, the surroundings sensor system used has a detection range, the detection range being divided at least into critical and noncritical ranges; in the detection step, an optical flow of the detection range is detected or the detection range is detected multiple times in succession, and enabling of the control decision takes place when the feature having a predetermined minimum size is detected, and when either the feature is detected in a critical range, or a movement of the feature from a noncritical range into a critical range is detected.

In an example embodiment, the detected feature, for example the vehicle license plate, must be localized in the video image in particular regions (critical ranges) in image sequences (at least two images) or an optical flow in order to detect and plausibility-check an unavoidable impact at a relevant speed.

The regulatorily standardized feature in the image or in the detection range can be recognized via template matching methods (correlation of templates with the image or the detection range) or via other methods, which, for example, analyze the gray scales, for example maximally stable extremal regions (MSERs). Suitable templates are stored in the memory of the evaluation unit.

In one advantageous specific embodiment, a size or a distortion of the feature or a position in the detection range of the feature is detected, and based on the size and/or the distortion and/or the position, a collision severity or a collision time or an angle of impact or a point of impact for the vehicle is determined, the enabling taking place as a function of the collision severity or the collision time or the angle of impact or the point of impact.

The regulatorily standardized feature is accepted in the image only in certain sizes/orientations/distortions. If the rotation/shearing, etc., exceeds a certain level, plausibility is not present; i.e., the control is not enabled. Threshold values for the particular attributes (size, orientation, distortion) are predetermined for this purpose.

In one advantageous specific embodiment, enabling takes place only when the feature has been detected with a predetermined quality, in particular when the contrast of the detected feature exceeds a predetermined threshold value.

Due to this specific embodiment, the situation is advantageously avoided that a plausibility check takes place based on vehicle license plates that have come off and are lying on the roadway, since such license plates exceed the maximum possible shearing or rotation.

In an example embodiment, the regulatorily standardized features are accepted only when the contrast and image quality are adequate. If the contrast or the image quality drops, plausibility is not present (threshold value comparison); i.e., the control is not enabled. This ensures that a plausibility check with a minimum quality is provided.

Due to this specific embodiment, the situation is advantageously avoided that depictions of vehicles result in enabling, since there is no plausibility check for newspaper pages flying around, on account of the necessary temporal development and requirement for contrast and image quality.

In one advantageous specific embodiment, a method for optical character recognition is applied to the detected license plate, and the enabling takes place based on the method for optical character recognition.

Methods for optical character recognition (OCR) recognize the characters used for the vehicle license plate. By recognition of the characters, it can be easily made sure that the detected features involve a (valid) vehicle license plate. In principle, use of a method for optical character recognition is also applicable to other regulatorily standardized features.

In one advantageous variant of this specific embodiment, the syntax of the recognized characters is checked for correctness. When there is a violation of the syntax rules, plausibility is not present; i.e., the control is not enabled.

In one advantageous specific embodiment, the detected license plate is correlated with other features of the motor vehicle, and enabling takes place when the correlation is conclusive.

The surroundings of the detection range are analyzed, based on the detected regulatorily standardized feature. For example, symmetry tests or self-image checks are carried out to determine features that are specific for the vehicle front end or rear end. If these features are not found, plausibility is not present; i.e., the control is not enabled.

Methods for checking the surroundings of the detection range for motor vehicle-specific features are known as standard methods from the literature.

In an example embodiment, the regulatorily standardized feature is accepted only if it can be found in the image sequence in predefined regions, in certain sequences. If the sequence is incorrect, plausibility is not present. The dynamic estimation can optionally also be ensured by comparison with the motion blur of the regulatorily standardized feature.

In one advantageous specific embodiment, the method includes an additional step of ascertaining the instantaneous position of the vehicle with the aid of a device for position determination, in particular with the aid of a GNS system, the step of detecting being a function of the ascertained position of the vehicle.

The probability of a collision can be empirically deduced from the vehicle license plate of the other collision participant. A probability as a (non)linear function of the distance is conceivable. Example: The probability is highest for local license plates, and is lowest for foreign license plates from distant locations. The threshold is adjusted based on regional collision pairings.

Furthermore, it is also conceivable, based on the determined position, to use the templates for an employed template matching method. Thus, it is not necessary to initially compare the detected signals to all available templates, but, rather, to initially compare them to those that are most relevant for the determined position. The template matching method used is greatly speeded up in this way.

In another advantageous specific embodiment, a stereo surroundings sensor system, in particular a stereo video sensor system, is used as a surroundings sensor system, it being possible to determine a distance from the regulatorily standardized feature based on the disparity of the detected feature in the particular stereo images. A distance from the collision object is estimated from this determined distance. In the step of enabling, the determined or estimated distance is taken into account; i.e., the enabling also takes place as a function of the determined or estimated distance.

Advantageous specific embodiments of the present invention are illustrated in the drawings and described below. Components or elements that carry out identical or similar functions are denoted by the same reference numerals in the drawings.

### BRIEF DESCRIPTION OF THE DRAWINGS

FIG. 1 is a block diagram of a method for making a control decision for a safety device, according to an example embodiment of the present invention.

FIG. 2 is a block diagram of a method for controlling a safety device according to an example embodiment of the present invention.

FIG. 3 is a flowchart of a method for video-based vehicle license plate recognition.

FIG. 4 illustrates characteristic features of a vehicle, according to an example embodiment of the present invention.

FIG. 5 illustrates a schematic classification of a detection range of a surroundings sensor system, according to an example embodiment of the present invention.

### DETAILED DESCRIPTION

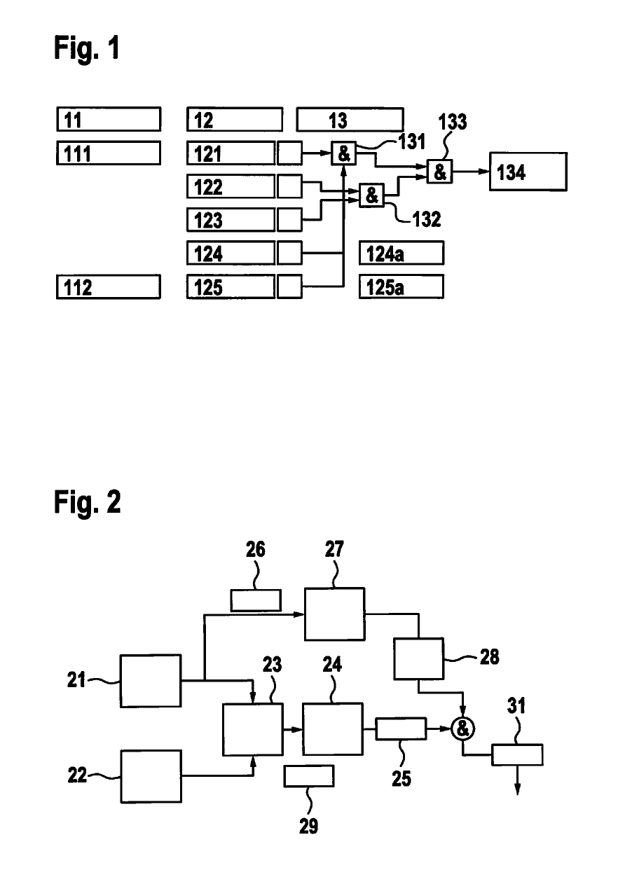

FIG. 1 is a block diagram that illustrates a method for making a control decision for a safety device for a vehicle, according to an example embodiment of the present invention.

The two main components, collision severity determination 111 and collision prediction 112, are in block 11. Various input variables 12 are used for collision severity determination 111; these include, for example, relative speed 121, mass 122 of the collision object, rigidity 123 of the collision object, and collision type or collision geometry 124. Known collision types or geometries are the front end collision (full frontal), the offset deformable barrier (ODB) collision, etc.

Collision probability 125, among other factors, is used as an input variable 12 for collision prediction 112.

These input variables 12 are combined with one another in control method 13. Thus, in the illustrated specific embodiment, relative speed 121, collision type or geometry 124, and collision probability 125 are linked 131 to each other with the aim of ascertaining whether a relevant collision type 124a will occur at a relevant point of impact 125a. In addition, mass 122 of the collision object and rigidity 123 of the collision object are linked 132 to each other.

In the illustrated specific embodiment, the results of the two linkages 131, 132 are linked 133 to each other in order to conclude whether a collision will take place with an energy input 134 that is relevant for a triggering.

The illustrated exemplary embodiment represents only one possible specific embodiment of a control method for safety means.

FIG. 2 is a block diagram that shows one specific embodiment of a control method for a safety device of a vehicle with a safety path.

Sensor signals, for example an optical flow, results of a pattern matching method or of a classifier, based on a video sensor system 21 with subsequent evaluation of the video signals or evaluation of reflections, object recognition, and tracking methods based on a radar sensor system with subsequent evaluation 22, are introduced into a fusion module 23 via surroundings sensor systems 21, 22.

A method according to the specific embodiment illustrated in FIG. 1 can be carried out in fusion module 23. Results 24 of the fusion module such as the estimated collision time, estimated collision probability 125, and the estimated collision severity result in a trigger decision 25.

A plausibility check takes place via a separate safety path 26, in parallel with the trigger decision. In the illustrated exemplary embodiment, the sensor signals of video sensor system 21 are incorporated into safety path 26. In one specific embodiment not illustrated, signals of a different surroundings sensor system, for example a lidar sensor system, an ultrasonic sensor system, or also illustrated radar sensor system 22, is/are used.

In the illustrated specific embodiment, video signals 21 in safety path 26 are evaluated, for example, with the aid of the method for plausibility checking according to the present invention. The result of safety path 26 is the enabling of the trigger process. This enabling can be effected, for example, by setting a corresponding flag. It would also be conceivable to generate a suitable signal. Since the present method is also intended for use in the context of precollision applications, it is likewise conceivable for a positive plausibility check to be held in reserve for a predetermined time. Triggering 31 of the safety device takes place only when evaluation path 29 as well as safety path 26 conclude that controlling the safety device is required.

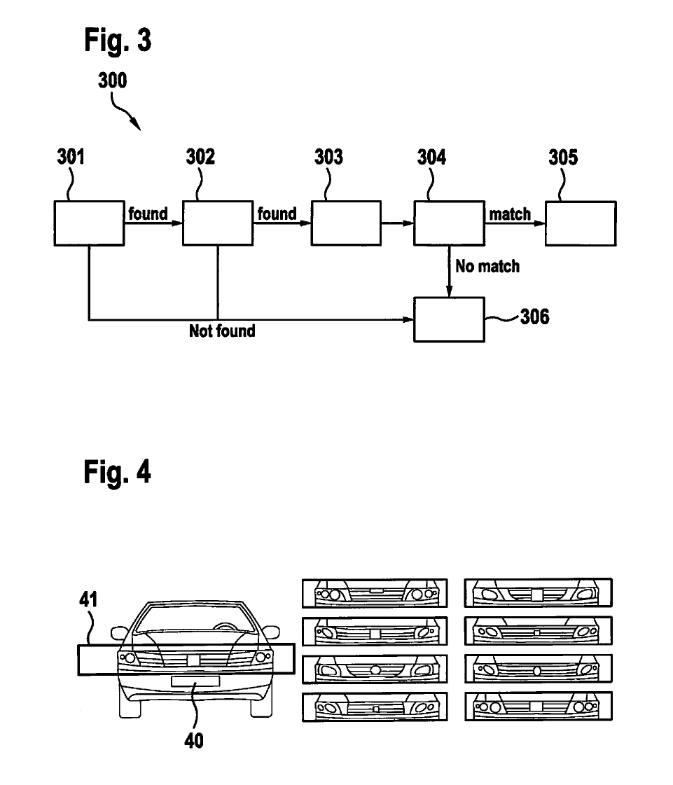

FIG. 3 is a flowchart of a method for video-based vehicle license plate recognition according to the related art. A vehicle license plate is detected as a regulatorily standardized feature in step 301. The vehicle front end panel is localized in step 302. An analysis of the detected vehicle license plate and the vehicle front end panel is carried out in step 303. A classification 304 of the analysis is carried out in step 303. Results of classification step 304 can be, among others, the ascertainment of relative speed 121, mass 122, and rigidity 123 of the collision object, collision type or geometry 124, and collision probability 125 (see FIG. 1).

If classification step 304 concludes that a collision or an imminent collision is plausible, enabling 305 of the control of the safety device takes place. If one of steps 301 through 303 fails, or if classification 304 concludes that a collision or an imminent collision is not plausible, enabling 306 of the control of the safety device does not take place.

FIG. 4 shows an example of how section 41 to be examined for analyzing the vehicle front end panel is ascertained in the surroundings of the detection range around detected vehicle license plate 40 as a regulatorily standardized feature of a vehicle, based on the localization of vehicle license plate 40. Approaches are known from the related art for classifying characteristic features of a vehicle, based on “landmark license plate” 40, using the eigenfaces approach. Approaches proceed from a so-called eigenface recognition. The information in the detection range or in the detection range that is reduced based on the localized vehicle license plate (left side of FIG. 4) is compared to a collection of eigenfaces (right side of FIG. 4), i.e., templates of known vehicle front end panels. Methods based on the linear combination of basic elements known from the area of facial recognition can be used.

License plate 40 can be utilized as a landmark to carry out a more in-depth analysis.

Criteria for the classifier could be the residuum (threshold value comparison) of the reconstruction or the analysis of the location in feature space. Discriminating hypersurfaces can be implemented and queried here (support vector machine, neuronal networks, threshold values, etc.).

Region of interest 41 can also include the entire vehicle, depending on the analysis. Powerful methods of data-driven image segmentation can be used here (watershed algorithm, growing regions, edge pulls, template matching methods, etc.). The results of the segmentation can be compared to vehicle outlines.

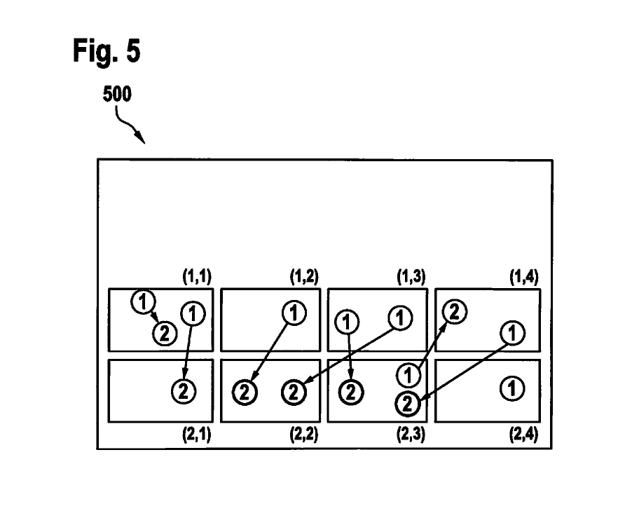

FIG. 5 shows a schematic classification of a detection range 500 of a surroundings sensor system. Detection range 500 is classified into noncritical ranges (1, 1), (2, 1), (1, 2), (1, 3), (1, 4), (2, 4) and critical ranges (2, 2), (2, 4). Elements depicted as circles represent detected features. A circle containing a “1” is the position of the feature at a first point in time. A circle containing a “2” is the position of the feature at a second point in time. The arrow between a feature at a first point in time and at a second point in time represents the movement of the recognized feature from the first to the second point in time. For plausibility checking a collision or an imminent collision, the feature movements within critical ranges (2, 2), (2, 4) or from a noncritical range (1, 1), (2, 1), (1, 2), (1, 3), (1, 4), (2, 4) into a critical range (2, 2), (2, 4) are detected.

The grayscale image is divided into regions. The localizations are associated with these regions. The (schematic) acceptance rules pertinent to FIG. 5 are:

First localization in the region with index (1, Y), where Y is made up of {1, 2, 3, 4}.

Second localization in the region with index (X, 2), where X is made up of {2, 3}.

The classifications and transitions are set in such a way that an unambiguous distinction can be made between the transitions to unavoidable collisions, and successful evasive maneuvers.

1-15. (canceled)

16. A method for checking the plausibility of a control decision for a safety control of a vehicle, the method comprising:
detecting a regulatorily standardized feature of a collision object using a surroundings sensor system; and
enabling the control decision based on the detected feature.

17. The method of claim 16, wherein the collision object is a motor vehicle, and the feature is at least one of a license plate, a hazard label, and a warning sign for the motor vehicle.

18. The method of claim 17, wherein a method for optical character recognition is applied to the detected license plate, and the enabling takes place based on the method for optical character recognition.

19. The method of claim 18, wherein characters recognized with the aid of the method for optical character recognition are compared to a predetermined syntactic rule, and the license plate is used as the feature only when the recognized characters correspond to the syntactic rule.

20. The method of claim 17, wherein the detected license plate is correlated with other features of the motor vehicle, and enabling takes place when the correlation is conclusive.

21. The method of claim 16, wherein the surroundings sensor system has a detection range divided at least into critical ranges and noncritical ranges, and, in the detecting, an optical flow of the detection range is detected or the detection range is detected multiple times in succession, and enabling of the control decision takes place in response to (a) detection of the feature having a predetermined minimum size, and (b) detection of the feature in, or of movement of the feature from a noncritical range into, one of the critical ranges.

22. The method of claim 21, wherein a collision speed is determined from the detected movement, and the enabling takes place as a function of the determined collision speed.

23. The method of claim 21, wherein:
at least one of (a) a size of the feature is detected, (a) a distortion of the feature is detected, and (c) a position in the detection range of the feature is detected;
based on the at east one of the detected size, distortion, and position, at least one of a collision severity, a collision time, an angle of impact for the vehicle, and a point of impact for the vehicle is determined; and
the enabling takes place as a function of the at least one of the collision severity, the collision time, the angle of impact, and the point of impact.

24. The method of claim 16, wherein the enabling takes place only when the feature has been detected with a predetermined quality.

25. The method of claim 16, wherein the enabling takes place only when a contrast of the detected feature exceeds a predetermined threshold value.

26. The method of claim 16, further comprising ascertaining an instantaneous position of the vehicle using a position determination device, wherein the step of detecting being a function of the ascertained position of the vehicle.

27. The method of claim 26, wherein the position determination device is a GNS system,

28. The method of claim 16, wherein at least one of the detection and the enabling takes place prior to contact with the collision object.

29. The method of claim 16, wherein the control takes place in the event of an imminent collision with a collision object.

30. A non-transitory computer-readable medium on which are stored instructions that are executable by a processor, and that when executed by the processor, cause the processor to perform a method for checking the plausibility of a control decision for a safety control of a vehicle, the method comprising:
obtaining from a surroundings sensor system a signal indicating a detection of a regulatorily standardized feature of a collision object; and
enabling the control decision based on the detected feature.

31. A device for a controlling a safety control of a vehicle, the device comprising:
a surroundings sensor system configured to detect a regulatorily standardized feature of a collision object; and
processing circuitry interfacing with the surroundings sensor system, wherein the processing circuitry is configured to obtain from the surroundings sensor system a signal indicating the detection of the regulatorily standardized feature and, based on the detected feature, enable a control decision for the safety control.
